(19) United States
(12) Patent Application Publication
(10) Pub. No.: US 2015/0130809 A1
(43) Pub. Date: May 14, 2015

(54) INFORMATION PROCESSOR, INFORMATION PROCESSING METHOD, PROGRAM, AND IMAGE DISPLAY DEVICE

(71) Applicant: Sony Corporation, Tokyo (JP)

(72) Inventors: Naoki Tagami, Tokyo (JP); Hiroshi Kyusojin, Tokyo (JP); Kenji Yamane, Kanagawa (JP); Hirofumi Watanabe, Kanagawa (JP)

(21) Appl. No.: 14/402,594

(22) PCT Filed: May 9, 2013
(86) PCT No.: PCT/JP2013/002980

§ 371 Date: Nov. 20, 2014

(30) Foreign Application Priority Data
Jun. 4, 2012 (JP) 2012-126807
Jun. 28, 2012 (JP) 2012-145499

(51) Int. Cl. G06T 3/40; G02B 21/36

(52) U.S. Cl. CPC G06T 3/40; G02B 21/367; G06T 2210/36
USPC 345/428

(57) ABSTRACT

An information processing apparatus comprising an image selecting portion configured to select an image to be displayed having a resolution determined based on a change speed of a display area, such as a movement, enlargement, reduction, a rotation or a change of focus position of the display area. Preferably when the display area stands still or is moved at low speed the high resolution image is displayed, and the low resolution is displayed when the change speed of the display area is fast. The apparatus relates particularly to an image observed with a microscope, and allows an image to be displayed without delay thereby facilitating diagnosis.

### TECHNICAL FIELD

The present technique relates to an information processor which controls display of an image captured by a microscope, an information processing method, a program, and an image display device. More particularly, the present technique relates to a technique for changing a display area and display magnification of an image observed with a microscope (microscope-observed image) in accordance with an instruction of a user.

### BACKGROUND ART

In the fields of medical services, pathology, animate beings, materials and the like for the purpose of obtaining a microscope-observed image having a wide viewing field and high magnification, there is used a technique with which an area as a physical subject for an observation is divided and captured with a digital microscope, and plural partial images thus obtained are pieced. A virtual microscope system using this technique can display an arbitrary position at arbitrary magnification with respect to the resulting microscope-observed image by a user. Also, the virtual microscope system using this technique can display an arbitrary position in a remote place through a network. Therefore, the virtual microscope system using this technique especially attracts attention in a tissue and/or cell inspection application in a pathology diagnosis.

In general, in the virtual microscope system, data created in such a way that a synthesized . microscope-observed image having a wide viewing field and a high resolution is subjected to mipmap, and is divided into tile-like small images with respect to mipmap hierarchies. Also, a displayed image having arbitrary magnification is created from the data thus created with respect to an arbitrary position of the microscope-observed image by, for example, an image viewer function of an image processor, and is then displayed on an image display device. In addition, in the case where a display range is changed by the user, after the image viewer function reads into image data in a new display range and converts the image data into a displayable data format, the image viewer function transfers the data obtained through the conversion to a frame buffer.

On the other hand, since the microscope-observed image acquired from the virtual microscope system is captured at a high resolution, and thus an amount of data is large, it takes time to execute processing for carrying out display and to receive/transmit data. Then, hereinafter, an information processing method of estimating an image for which the possibility that the image concerned is requested is high based on hint information representing display contents of a microscope-observed image which is carried out in an image display device for the purpose of suppressing reduction of a response performance due to a network response delay (refer to Patent Literature 1).

In addition, in a technique for decoding a multi-resolution image there is proposed a method of reducing a resolution of a circumferential area of a watched area for the purpose of decoding and displaying a high-quality image at a high speed in response to a change in a display area from a user (refer to Patent Literature 2). In the method of decoding the multi-resolution image described in this Patent Literature 2, for example, the resolution of the circumferential area is determined based on an amount of movement of the watched area in a user manipulation.

### CITATION LIST

### Patent Literature

PTL 1: JP 2012-14251A

PTL 2: JP 2011-176570A

### SUMMARY

### Technical Problem

However, the existing art described above involves a problem such that the processing speed is not increased enough to be expected depending on the execution environment such as the throughput of the information processor for executing display processing, and a communication performance when the data is received/transmitted through the network. For example, in the case where the throughput of the network is small, in the case where the processing speed of the hard disk is slow, in the case where the load of the server is large, and the like, the speed at which the image data is read into the information processor becomes low. In addition, in the case where the processing speed of a Central Processing Unit (CPU) is low, in the case where the load of the information processor is large due to other processing such as image processing, and the like, the speed of processing for converting the image data format becomes low.

When in such a state, the display position is changed at a high speed, the update of the picture becomes too late, and thus there is caused a problem such that the display is delayed, and a part of the image is not displayed, and so forth. In the pathology diagnosis, since a problematic portion is found out while the display range is moved, the problematic portion is roughly estimated, and so forth, when a lack is present in a part of the picture in the phase of the movement display, it is impossible to carry out the effective diagnosis. From such a reason, the improvement in the responsibility for the instruction issued by the user is required for the image viewer function of the virtual microscope system.

It is noted that although as with the method described in Patent Literature 2, the processing speed can be improved to a certain extent when the resolution of a part of the displayed image is reduced, it is necessary for the application of this technique to set the watched area of the user in the displayed image. In this case, in addition to the manipulation for the observation with the optical microscope, a manipulation for setting the watched area within the viewing field is increased in number thereof by one. Although “the operability equal to the optical microscope” is required for the virtual microscope system, when the technique described in Patent Literature 2 is applied, this requirement is not met because the operability is reduced.

In the light of the foregoing, it is therefore a principal object of the present disclosure to provide an information processor which is capable of displaying an image in a specified area without any delay, an information processing method, a program, and an image display device.

### Solution to Problem

According to an embodiment of the present disclosure, an information processing apparatus comprising an image selecting portion is provided. The image selecting portion is configured to select an image to be displayed having a resolution determined based on a change speed of a display area.

According to an embodiment of the present disclosure, an information processing method is provided. The information processing method comprising selecting an image to be displayed having a resolution determined based on a change speed of a display area. A non-transitory computer readable storage medium is also provided that stores a computer program for causing an information processing apparatus to select an image to be displayed having a resolution determined based on a change speed of a display area.

According to an embodiment of the present disclosure, an image display device is provided. The image display device comprising a display portion, and an image acquiring portion configured to acquire an image to be displayed having a resolution determined based on a change speed of a display area.

According to an embodiment of the present disclosure, an image display system is provided. The image display system comprising an information processing apparatus including an image selecting portion configured to select an image to be displayed having a resolution determined based on a change speed of a display area.

It is noted that in the present disclosure, “the resolution” of each of the microscope-observed images stored in the image storing portion is the number of pixels per unit length. In addition, “the display magnification” is magnification of a resolution of a displayed image to a resolution of an original image (an image having the highest resolution in an image group), and “the resolution corresponding to the display magnification” is the product of the resolution of the original image and the display magnification.

### Advantageous Effect of Invention

According to the present disclosure, since the resolution of the image to be selected is determined based on the change speed of the specified display area, the image of the specified area can be displayed without any delay.

### BRIEF DESCRIPTION OF DRAWINGS

FIG. 1 is a view showing an outline of a microscope system of a first embodiment of the present disclosure.

FIG. 2 is a block diagram showing a configuration example of an information processor 2 shown in FIG. 1.

FIG. 3 is a view showing a structure of an image group having a mipmap format created in an image synthesizing portion 23.

FIG. 4 is a plurality of conceptual views showing an example of display changes: view A indicates a movement; view B a rotation; and view C an enlargement.

FIG. 5 is a flow chart showing a basic operation of an image viewer function in the information processor 2.

FIG. 6 is a flow chart showing an operation of an image selecting portion 24.

FIG. 7 is a view showing a mipmap selecting method when a specified area either stands still or is moved at a low speed.

FIG. 8 is a view showing a mipmap selecting method when a specified area is moved at a high speed.

FIG. 9 is a chart showing a relationship between a display speed and a selection reference of a mipmap.

FIG. 10 is a diagram showing a method of selecting a tile image to be decided.

FIG. 11 is a block diagram showing a configuration example of an image display device of a microscope system according to a modified change of the first embodiment of the present disclosure.

FIG. 12 is a conceptual view showing an image group of a mipmap format created in a microscope system according to a second embodiment of the present disclosure.

### DESCRIPTION OF EMBODIMENTS

Hereinafter, modes for carrying out the present disclosure will be described in detail with reference to the accompanying drawings. It is noted that the present disclosure is by no means limited to embodiments which will be described below. In addition, the description is given in accordance with the following order.
1. First Embodiment
   (an example in which a resolution of an image to be selected is determined based on a change speed of a specified area)
2. Modified Change of First Embodiment
   (an example in which an image is acquired in an image display device)
3. Second Embodiment
   (an example of an image viewer in which a focus position can also be changed)

### 1. First Embodiment

### Configuration of Microscope System

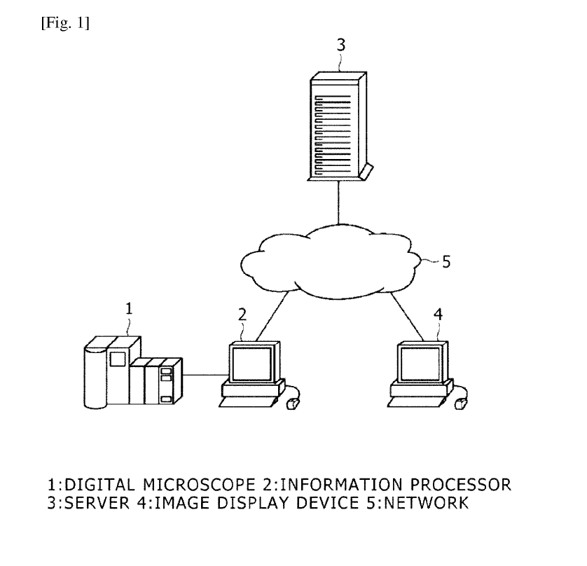

Firstly, a description will now be given with respect to a virtual microscope system according to a first embodiment of the present disclosure. FIG. 1 is a view showing an outline of a microscope system of this embodiment. The microscope system of this embodiment captures and observes various kinds of prepared specimens for a microscopic observation and, for example, as shown in FIG. 1, is composed of a digital microscope 1, an information processor 2, an image display device 4, and the like.

In the microscope system of this embodiment, the information processor 2 and the image display device 4 may be directly connected to each other, but may be connected to each other through a network 5. In addition, the information processor 2 and the image display device 4 may also be connected to a server 3 through the network 5 so as to be capable of mutually communicating with the server 3. In addition, although in the configuration shown in FIG. 1, only one image display device 4 is shown, two or more image display devices 4 may also be connected, or the information processor 2 may also serve as the image display device 4 as well.

Although the virtual microscope system of this embodiment can be applied to various kinds of fields such as medical services, pathology, animate beings, materials, and the like, when the virtual microscope system of this embodiment, for example, is used for a pathology diagnosis, a physical object for an observation is an organ, a tissue, a cell or the like of an animate being, and a section thereof is enclosed within the prepared specimen for a microscopic observation.

### Digital Microscope 1

The digital microscope 1 includes a light source, an objective lens, an image pickup element, a stage, and the like. The digital microscope 1 radiates a predetermined illumination light to a prepared specimen for a microscopic observation placed on the stage, and captures a light transmitted through a physical object for an observation, a light emitted from the physical object for an observation, and the like. A digital image captured by the digital microscope 1 is outputted to the information processor 2.

### Information Processor 2

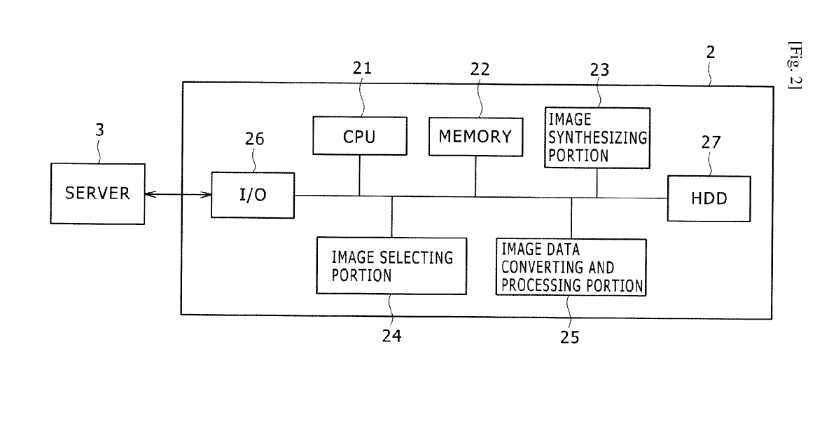

FIG. 2 is a block diagram showing a configuration example of the information processor 2. As shown in FIG. 2, the information processor 2 includes a Central Processing Unit (CPU) 21, a memory 22, an image synthesizing portion 23, an image selecting portion 24, an image data converting and processing portion 25, an input/output interface portion 26, a hard disk 27, and the like.

(Image Synthesizing Portion 23)

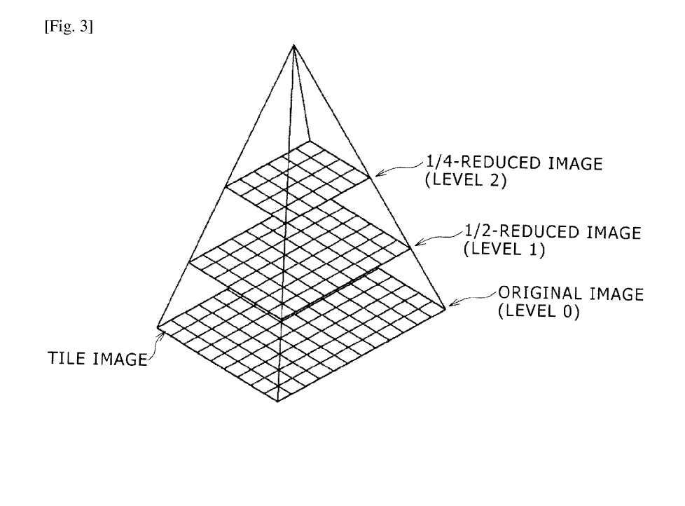

The image synthesizing portion 23 processes the digital image captured by the digital microscope 1 to generate a microscope-observed image having a high resolution, and creates a mipmap of the microscope-observed image thus generated. FIG. 3 is a view showing a structure of an image group of the microscope-observed image thus generated.

As shown in FIG. 3, in the image group, an original image having a maximum resolution is located in a bottom portion (at a mipmap level of 0), and a ½-reduced image of the original image (at a mipmap level of 1) and ¼-reduced image of the original image (at a mipmap level of 2) are laminated one upon another in this order. That is to say, the image group created in the image synthesizing portion 23 is composed of plural microscope-observed images which are different in resolution from one another in the same viewing field, and thus has a pyramid structure in which the plural microscope-observed images are laminated in such a way that the resolution becomes small as the microscope-observed images are located in the upper layer. Here, “the resolution” in each of the microscope-obtained images is the number of pixels per unit length.

In addition, each of the mipmaps of the image group created in the image synthesizing portion 23 may be divided into plural tile images. In this case, each of the tile images, for example, is compressed in accordance with a format such as JPEG or JPEG 2000, and is stored either in the hard disk 27 within the information processor 2 or in an image storing portion provided within the server 3 on the network 5. Plural microscope-observed images which are different in resolution from one another are prepared in such a way, and each of the microscope-observed images is composed of plural tile images, whereby when the microscope-observed images are perused by using the image viewer function, enlarging and reducing processing straddling the resolution levels can be efficiently carried out.

(Image Selecting Portion 24)

The image selecting portion 24 selects an image to be displayed from the image group stored in the image storing portion based on display area specifying information inputted by the user. In this case, the image selecting portion 24 determines the image having which of the resolutions is selected based on the change speed of the specified display area.

Specifically, the image selecting portion 24 selects the image having the lower resolution than the resolution corresponding to the display magnification when the change speed of the specified display area is equal to or higher than a threshold value, and selects either the image having the higher resolution than the resolution corresponding to the display magnification or the resolution corresponding to the display magnification when the change speed of the specified display area is lower than the threshold value. Here, “the display magnification” is magnification of a resolution of a displayed image to a resolution of an original image, and “the resolution corresponding to the display magnification” is the product of the resolution of the original image and the display magnification.

In addition, when as shown in FIG. 3, each of the mipmaps of the pixel group is composed of plural tile images, the image selecting portion 24 firstly determines the resolution of the image to be selected based on the change speed of the specified display area. Also, the image selecting portion 24 extracts one or plural tile images corresponding to the specified display area from the image having the specific resolution selected by the image selecting portion 24.

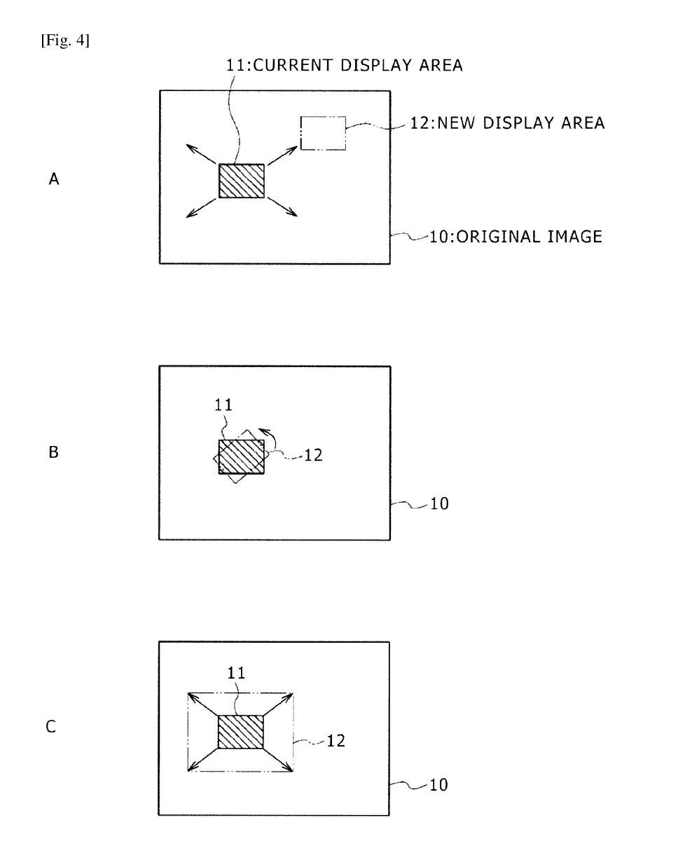

In this embodiment, as far as the change of the display area concerned, there, for example, are supposed a movement, a rotation, an enlargement or a reduction, a combination thereof, and the like. FIG. 4 is a plurality of conceptual views showing an example of display changes: view A indicates a movement; view B a rotation; and view C an enlargement. Also, when the display change is the movement (pan) shown in FIG. 4A, “the change speed of the display area” can be evaluated by an amount of movement per unit time. In addition, when the display change is the rotation (tilt) shown in FIG. 4B, “the change speed of the display area” can be evaluated by an angle of a rotation per unit time.

In addition thereto, when the display change is the enlargement (zoom-out) shown in FIG. 4B, “the change speed of the display area” can be evaluated by an increasing area (the number of tiles) per unit time. Similarly, when the display change is the reduction (zoom-in) shown in FIG. 4B, “the change speed of the display area” can be evaluated by a phenomenon area (the number of tiles) per unit time.

(Image Data Converting and Processing Portion 25)

The image data converting and processing portion 25 executes decoding processing (decode) for converting the data format of the tile images selected by the image selecting portion 24. In addition, in the image data converting and processing portion 25, as may be necessary, the size of the image selected by the image selecting portion 24 is adjusted and thus the image having the same size as that of the specified display area is generated.

Specifically, when the image selecting portion 24 selects the image having the lower resolution than the resolution corresponding to the display magnification, the image data converting and processing portion 25 enlarges the image concerned. In addition, when the image selecting portion 24 selects the image having the higher resolution than the resolution corresponding to the display magnification, the image data converting and processing portion 25 reduces the image concerned. It is noted that when the resolution of the image selected by the image selecting portion 24 is the same with the resolution corresponding to the display magnification, the adjustment of the image size described is unnecessary.

### Image Viewer Function

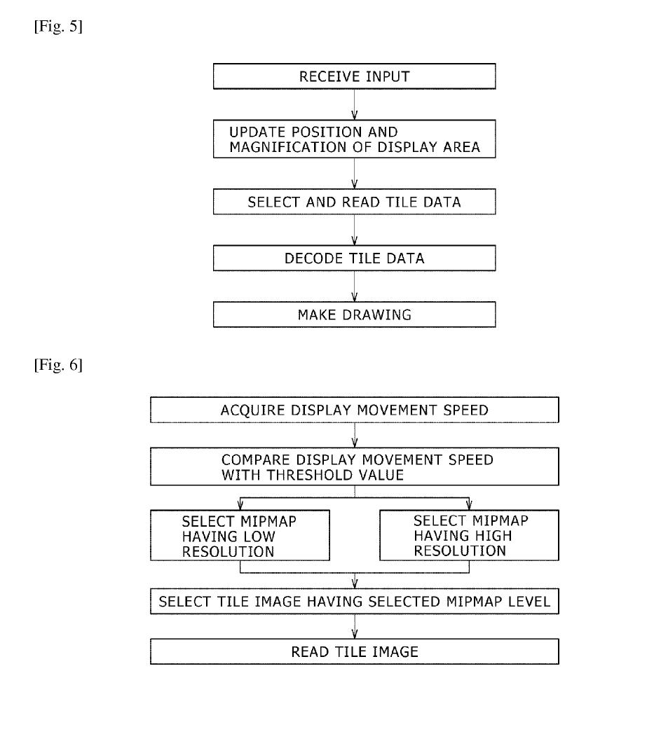

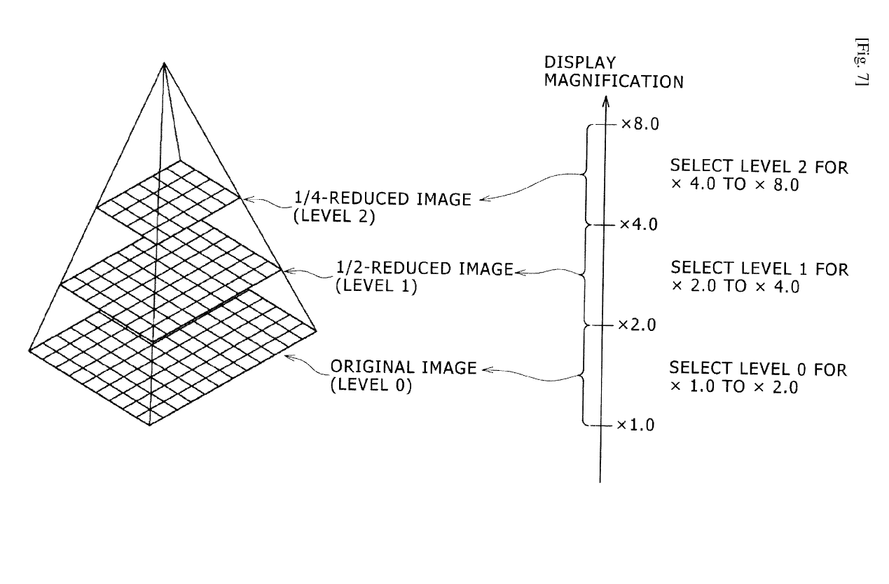

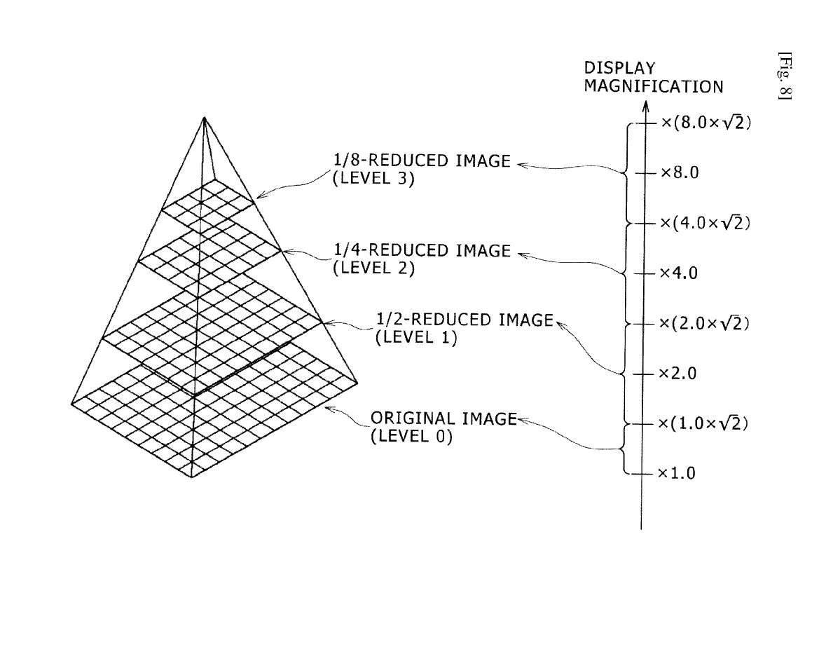

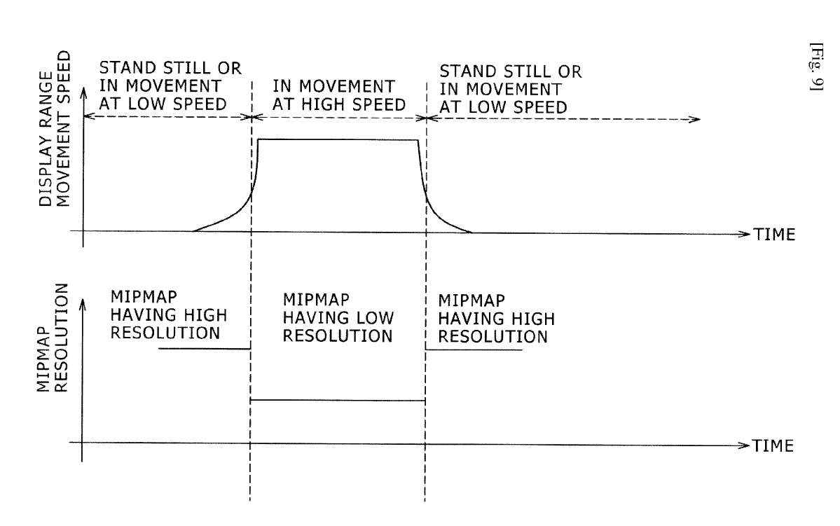

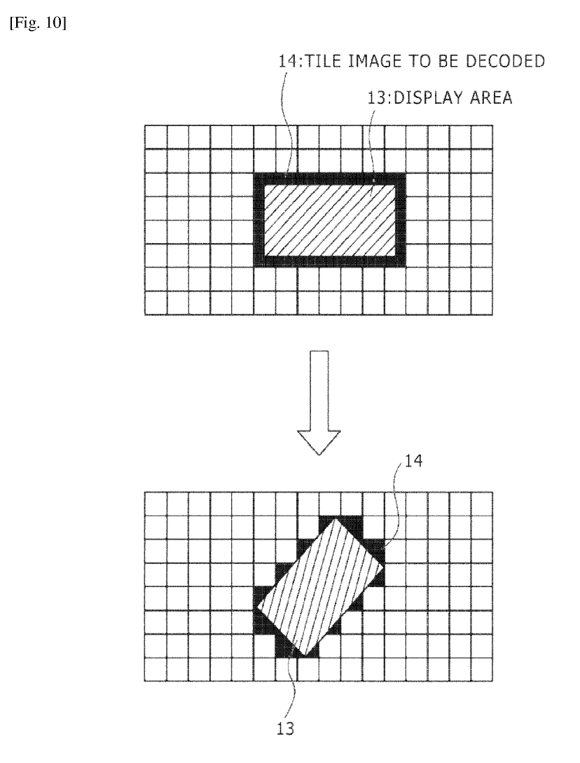

Next, a description will now be given with respect to an image viewer function of the information processor 2. FIG. 5 is a flow chart showing a basic operation of the image viewer function in the information processor 2, and FIG. 6 is a flow chart showing an operation of the image selecting portion 24. In addition, FIG. 7 is a view showing a mipmap selecting method when the specified area either stands still or is moved at a low speed, FIG. 8 is a view showing a mipmap selecting method when the specified area is moved at a high speed, and FIG. 9 is a chart showing a relationship between a display speed and selection criteria for the mipmap. In addition thereto, FIG. 10 is a diagram showing a method of selecting a tile image to be decoded.

As shown in FIG. 5, when the display area specifying information inputted by the user is inputted to the information processor 2 through the input/output interface 26, the position and the magnification of the display range are updated, the specific image is selected by the image selecting portion 24, and the tile image is extracted. In this case, the image selecting portion 24 determines the resolution of the image to be selected based on the change speed of the display area specified by the user.

Specifically, as shown in FIG. 6, the movement speed of the display area is acquired, the value of the movement speed and the threshold value are compared with each other, and the image having which of the resolutions is selected is determined in accordance with the comparison result. For example, when as shown in FIGS. 7 and 9, the specified area either stands still or is moved at the low speed, the image having either the resolution corresponding to the display magnification or the high resolution (in which the mipmap level is low) equal to or higher than the resolution concerned is selected. Thus, the image having the higher quality is displayed. On the other hand, when as shown in FIGS. 8 and 9, the specified area is moved at the high speed, the image having the lower resolution (in which the mipmap level is high) than the resolution corresponding to the display magnification is selected, whereby the processing speed is made fast although the image quality is reduced.

Since the resolution (mipmap level) of the image to be selected is changed in correspondence to the movement speed (change speed) of the specified display area, the image of the specified area can be displayed without any delay. In addition, with this method, since there is not caused such a problem that a part of the image is not displayed, the effective diagnosis can be carried out even in the use application such as the pathology diagnosis.

After that, as may be necessary, the decoding, the enlargement or the reduction is carried out in the image data converting and processing portion 25, the resulting image data is transmitted through the input/output interface 26 functioning as an image providing portion, and is then displayed on the image display device 4. In this case, when the change of the display area is “the rotation,” the tile image to be decoded is changed as shown in FIG. 10.

It is noted that a computer program in accordance with which the functions described above are carried out is created and is then mounted as a computer program to a personal computer or the like, thereby making it possible to realize the image viewer function. Such a computer program, for example, may be stored in a recording medium such as a magnetic disk, an optical disk, a magneto optical disk or a flash memory, and can be delivered through the network.

In addition, the image synthesizing portion 23, the image selecting portion 24, and the image data converting and processing portion 25 which are shown in FIG. 2 need not to be provided in the same information processor 2, but may also be provided in different information processors 2, respectively. In addition thereto, the image data converting and processing portion 25 may also be separately provided like an image data converting portion and the image processing portion.

### Server 3

The server 3 manages various kinds of pieces of data uploaded from the information processor 2, and outputs the various kinds of pieces of data to the image display device 4 and the information processor 2 in response to a request. For example, in the case where an image storing portion is provided in the server 3, it is only necessary to transmit information for selection of the image from the image selecting portion 24 to the server 3 through the input/output interface 26.

In addition, a Graphical User Interface (GUI) for the user of the image display device 4 may be provided in the server 3 and thus the image which can be perused in the image display device 4 may be created. In this case, the image selecting portion 24 and/or image data converting and processing portion 25 described above are (is) provided in the server 3, thereby making it possible to carry out these functions thereof.

### Image Display Device 4

The image display device 4 serves to display thereon the image provided therefor from the information processor 2 and thus all it takes is that the microscope-observed image can be perused on the image display device 4. In addition, a display information inputting portion may be provided in the image display device 4 such that the specification of the display area made by the user may be inputted to the image display device 4. In this case, the display area specifying information is transmitted from the image display device 4 to the information processor 2.

Here, although the method of specifying the display area is especially by no means limited, for example, a method of setting a display panel of a display device to a panel form and the like are expected. For example, when the prepared specimen for a microscopic observation is the pathology prepared specimen for a microscopic observation, the user of the image display device 4 (a reader for an image) is a doctor and he/she carries out the pathology diagnosis based on the display image.

### Network 5

The network 5 is a communication line network through which the information processor 2, the server 3, and the image display device 4 are connected so as to be capable of bidirectionally communicating with one another. This network 5, for example, is composed of a public line network such as the Internet, a telephone line network, a satellite communication network, or a simultaneous transmissive communication line, a private line network such as a Wide Area Network (WAN), a Local Area Network (LAN), the Internet Protocol-Virtual Private Network (IP-VPN), an Ethernet (registered trademark) or a wireless LAN, or the like, and thus a wired style or a wireless style is no object. In addition, the network 5 concerned may also be a communication line network which is provided exclusively for the microscope system of this embodiment.

As has been described in detail so far, since in the microscope system of this embodiment, the image having the low resolution is displayed when the change speed of the display area is fast, even if there is the shortage of the band of the network 5 or the lack of the throughput of the terminal, the user can grasp the entire display area without any interruption in viewing. On the other hand, since the image having the high resolution is displayed when the change speed of the display area is slow, even when the microscope system of this embodiment is used for the pathology diagnosis, the detailed diagnosis becomes possible.

### 2. Modified Change of First Embodiment

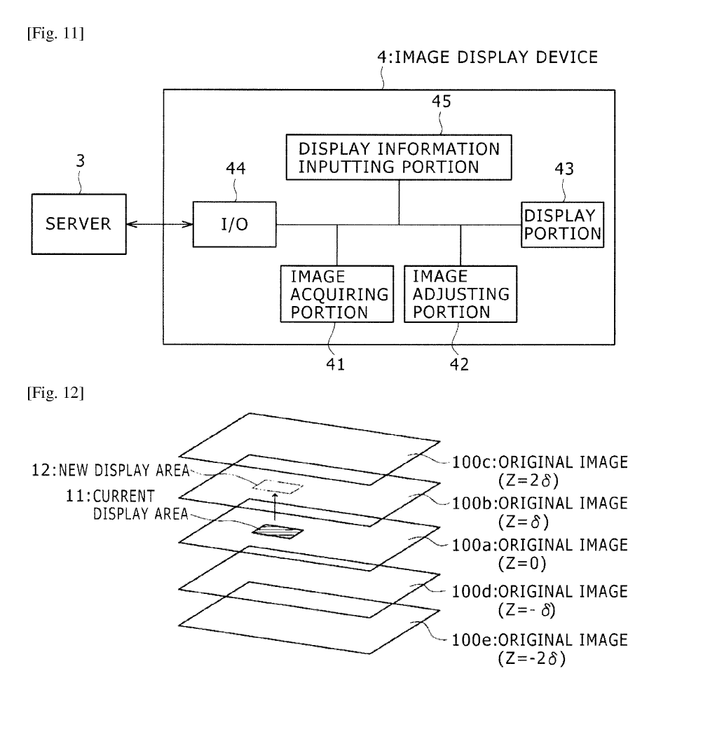

Next, a description will now be given with respect to a microscope system according to a modified change of the first embodiment of the present disclosure. FIG. 11 is a block diagram showing a configuration example of an image display device of the microscope system of this embodiment. As shown in FIG. 11, in the microscope system of the modified change, the image display device 4 is provided with an image acquiring portion 41 for acquiring a specific image based on the display area specifying information inputted by the user, and a display portion 42 for displaying thereon the image acquired by the image acquiring portion 41.

Although in the microscope system of the first embodiment described above, the image selecting portion 24 is provided in the information processor 2, the present disclosure is by no means limited thereto, and the image acquiring portion 41 may be provided in the image display device 4 instead of providing the image selecting portion 24 in the information processor 2. In addition, in the microscope system of this modified change, the image adjusting portion 42 can also be provided in the image display device 4 instead of the image data converting and processing portion 25 shown in FIG. 2. Hereinafter, a description will now be given with respect to a configuration of the image display device 4 used in the microscope system of this modified change.

### Image Acquiring Portion 41

The image acquiring portion 41 acquires a specific image from an image group composing of plural microscope-observed images which are different in resolution from one another in the same viewing field and which are stored in the image storing portion, for example, provided in the server 3 or the like based on the display area specifying information inputted by the user. With the image acquiring portion 41, similarly to the case of the image selecting portion 24 in the first embodiment described above, the resolution of the image to be acquired is determined based on the change speed of the specified display area.

With the image acquiring portion 41, for example, the image having the lower resolution than the resolution corresponding to the display magnification is acquired when the change speed of the specified display area is equal to or larger than the threshold value, and the image having either the resolution corresponding to the display magnification or the resolution equal to or higher than the resolution corresponding to the display magnification when the change speed of the specified display area is lower than the threshold value. As a result, when the specified area either stands still or is moved at the low speed, the image having the higher quality is displayed, and when the specified area is moved at the high speed, the processing speed can be made fast although the image quality is reduced.

### Image Adjusting Portion 42

In the microscope system of this modified change, the image display device 4 may be provided with the image adjusting portion 42 for enlarging or reducing the image acquired by the image acquiring portion 41, thereby creating the image having the same size as that of the specified display area. In the image adjusting portion 42, for example, when the image acquiring portion 41 acquires the image having the lower resolution than the resolution corresponding to the display magnification, the image concerned is enlarged. On the other hand, when the image selecting portion acquires the image having the higher resolution than the resolution corresponding to the display magnification, the image of the image concerned is reduced, thereby creating the image having the same size as that of the specified display area.

In addition, as may be necessary, the decoding of the tile image may be carried out in the image adjusting portion 42. Also, the image data which has been subjected to the decoding and the size adjustment in the image adjusting portion 42 is transmitted to and displayed on the display portion 43. It is noted that the image data which has been subjected to the adjustment and the like in the image adjusting portion 42 can also be transmitted to the server 3 through the input/output interface 44.

### Display Information Inputting Portion 45

In addition thereto, the image display device 4 may also be provided with a display information inputting portion 45 to which the user inputs the display area specifying information. In this case, the image acquired portion 41 acquires the specific image based on the display area specifying information inputted to the display information inputting portion 45.

In the microscope system as well of the modified change, since the resolution (mipmap level) of the image to be acquired is changed in accordance with the movement speed (change speed) of the specified display area, the image of the specified area can be displayed without any display. It is noted that the configuration, the operation, and the effects other than the foregoing in the microscope image system are the same as those in the microscope system of the first embodiment described above.

3. Second Embodiment

Next, a description will now be given with respect to a microscope system according to a second embodiment of the present disclosure. With the microscope system of the second embodiment, in addition to the movement, the rotation, and the enlargement or reduction, the microscope-observed image can be perused while the focus position is changed. FIG. 12 is a conceptual view showing image groups each having the mipmapformat which are created in the microscope system of this embodiment.

As shown in FIG. 12, in the microscope system of this embodiment, plural microscope-observed images (original images) 100a to 100e which are the same with viewing field and resolution to one another and which are different only in focus position from one another are stored in the image storing portion. Also, the minimaps are created with respect to the plural microscope-observed images 100a to 100e, respectively. As a result, plural image groups which are different only in focus position from one another are stored in the image storing portion of the microscope system of this embodiment.

Also, when the change of the focus position is inputted as the change of the display area by the user, the image selecting portion 24 of the information processor 2 specifies the image group corresponding to the specified focus position, and selects the image having an arbitrary resolution in correspondence to the change speed of the display area. That is to say, the image selecting portion 24 of the information processor 2 selects the image having the low resolution when the change speed of the focus position is fast, and the image selecting portion 24 of the information processor 2 selects the image having the high resolution when the change speed of the focus position is slow.

Plural image groups which are different only in focus position from one another are created in such a manner, whereby it is possible to realize the microscope system with which the microscope-observed image can be perused while the focus position is changed. Also, in the microscope system as well of this embodiment, since the resolution of the image to be selected is changed in correspondence to the change speed of the specified display area, the image of the specified area can be displayed without any delay.

It is noted that the configuration, the operation, and the effects other than the foregoing in the microscope image system of this embodiment are the same as those in the microscope system of the first embodiment described above. In addition, in the microscope system of this embodiment, like the microscope system of the modified change of the first embodiment described above, even when the image acquiring portion 41 and the image adjusting portion 42 are provided in the image display portion 4 instead of providing the image selecting portion 24 and the image data converting and processing portion 25 in the information processor 2, the same effects are obtained.

In addition, the present disclosure can also adopt the following constitutions.

(1)

An information processor having an image selecting portion configured to select a specific image from an image group composing of plural microscope-observed image which are different in resolution from one another in the same viewing field and which are stored in an image storing portion based on display area specifying information inputted by a user, in which the image selecting portion determines a resolution of the image to be selected based on a change speed of the specified display area.

(2)

The information processor described in (1), in which the image selecting portion selects the image having the lower resolution than a resolution corresponding to display magnification when the change speed of the specified display area is equal to or higher than a threshold value, and selects the image having the resolution equal to or higher than the resolution corresponding to the display magnification when the change speed of the specified display area is lower than the threshold value.

(3)

The information processor described in (1) or (2), in which each of the microscope-observed images of the image group is composed of plural tile images; and the image selecting portion extracts one or plural tile images corresponding to the specified display area from the image selected based on the display area specifying information.

(4)

The information processor described in any one of (1) to (3), further having an image processing portion configured to enlarge the image when the image selecting portion selects the image having the lower resolution than the resolution corresponding to display magnification, and reduce the image when the image selecting portion selects the image having the higher resolution than the resolution corresponding to display magnification, thereby creating an image having the same size as that of the specified display area.

(5)

The information processor described in (4), further including an image providing portion configured to provide the image created in the image processing portion for an image display on which the microscope-observed images can be perused.

(6)

The information processor described in (5), in which the image selecting portion selects the image based on the display area specifying information inputted to the image display device.

(7)

The information processor described in any one of (1) to (6), further having an image data converting portion configured to convert a data format of the image selected by the image selecting portion.

(8)

The information processor described in any one of (1) to (7), in which the change of the display area is at least one kind of manipulation of a movement, enlargement, reduction, and rotation.

(9)

The information processor described in any one of (1) to (8), in which plural image groups which are different in only focus position from one another are stored in the image storing portion; and

when the change of the display area is the change of the focus position, the image selecting portion specifies the image group corresponding to the specified focus position.

(10)

The information processor described in any one of (1) to (9), further including a communication portion which can communicate with a server on a network, in which the image storing portion is provided within the server; and information used to select the image is transmitted from the image selecting portion to the server through the communication portion.

(11)

An information processing method having an image selecting process for selecting a specific image from an image group composing of plural microscope-observed images which are different in resolution from one another in the same viewing field and which are stored either within an information processor or in an image storing portion provided within a server connected to the information processor based on display area specifying information inputted by a user by an image selecting portion provided in the information processor,

in which in the image selecting process, the image selecting portion determines a resolution of the image to be selected based on a change speed of a specified display area.

(12)

A program causing an information processor to carry out an image selecting function for determining a resolution of an image to be selected by a change speed of a specified display area based on display area specifying information inputted by a user, and selecting a specific image from an image group composing of plural microscope-observed images which are different in resolution from one another in the same viewing field.

(13)

An image display device having: an image acquiring portion configured to acquire a specific image from an image group composing of plural microscope-observed images which are different in resolution from one another in the same viewing field and which are stored in an image storing portion based on display area specifying information inputted by a user; and a display portion configured to display an image acquired by the image acquiring portion,

in which the image acquiring portion determines the resolution of the image to be acquired based on a change speed of a specified display area.

(14)

The image display device described in (13), in which the image acquiring portion acquires the image having the lower resolution than a resolution corresponding to display magnification when the change speed of the specified display area is equal to or higher than a threshold value, and acquires the image having the resolution equal to or higher than the resolution corresponding to the display magnification when the change speed of the specified display area is lower than the threshold value.

(15)

The image display device described in (13) or (14), further having: an image adjusting portion configured to, when the image acquiring portion acquires an image having the lower resolution than the resolution corresponding to the display magnification, enlarge the image and, when the image selecting portion acquires an image having the higher resolution than the resolution corresponding to the display magnification, reduce the image, thereby creating the image having the same size as that of the specified display area.

(16)

The image display device described in any one of (13) to (15), further having a display information inputting portion with which the user inputs the display area specifying information.

(17)

An information processing apparatus including:
an image selecting portion configured to select an image to be displayed having a resolution determined based on a change speed of a display area.

(18)

An information processing apparatus according to (17), wherein the resolution is determined based on whether the change speed is greater than or less than a predetermined threshold.

(19)

An information processing apparatus according to any one of (17) or (18), wherein if the change speed is less than the predetermined threshold, a high resolution image having a high resolution equal to or greater than a display magnification resolution corresponding to a display magnification of the display area is selected.

(20)

An information processing apparatus according to any one of (17) to (19), wherein if the change speed is greater than the predetermined threshold, a low resolution image having a low resolution lower than a display magnification resolution corresponding to a display magnification of the display area is selected.

(21)

An information processing apparatus according to any one of (17) to (20), wherein the image to be displayed includes a plurality of tile images that are adapted to be selected.

(22)

An information processing apparatus according to any one of (17) to (21), further including:

an image data converging and processing portion configured to convert a data format of the tile images.

(23)

An information processing apparatus according to any one of (17) to (22), further including:

an image data converting and processing portion configured to adjust a size of the image to be equal to a size of the display area if the resolution is not equal to a resolution corresponding to a display magnification.

(24)

An information processing apparatus according to any one of (17) to (23), wherein the display area is configured to be changed by a user input.

(25)

An information processing apparatus according to any one of (17) to (24), wherein the change speed is associated with at least one of a movement, an enlargement, a reduction, and a rotation of the display area.

(26)

An information processing apparatus according to any one of (17) to (25), further including:

an image acquiring portion configured to acquire the image to be displayed.

(27)

An information processing apparatus according to any one of (17) to (26), wherein the change speed is associated with a change of a focus position of the display area.

(28)

An information processing method including: selecting an image to be displayed having a resolution determined based on a change speed of a display area.

(29)

A non-transitory computer readable storage medium storing a computer program for causing an information processing apparatus to:

select an image to be displayed having a resolution determined based on a change speed of a display area.

(30)

An image display device including:

a display portion; and

an image acquiring portion configured to acquire an image to be displayed having a resolution determined based on a change speed of a display area.

(31)

An image display device according to (30), further including: a communication unit configured to transmit display area specifying information associated with the change speed.

(32)

An image display system including: an information processing apparatus including an image selecting portion configured to select an image to be displayed having a resolution determined based on a change speed of a display area.

(33)

An image display system according to (32), further including: a server including an image storing portion configured to store a plurality of images having a plurality of resolutions,

wherein the image selecting portion selects the image from the plurality of images.

(34)

An image display system according to (32), further including:

an image display apparatus including:

an image acquiring portion configured to acquire the image to be displayed having the resolution determined based on the change speed; and

a display portion configured to display the image to be displayed.

(35)

An image display system according to (33) or (34), further including:

a microscope configured to provide a plurality of original images to the server, wherein the plurality of images having the plurality of resolutions correspond to the original images.

(36)

An information processing apparatus including:

a processor; and

a memory device storing instructions which when executed by the processor, causes the processor to: select an image to be displayed having a resolution determined based on a change speed of a display area.

The present disclosure contains subject matter related to that disclosed in Japanese Priority Patent Application JP 2012-126807 filed in the Japan Patent Office on Jun. 4, 2012 and Japanese Priority Patent Application JP 2012-145499 filed in the Japan Patent Office on Jun. 28, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 Digital microscope

2 Information processor

3 Server

4 Image display device

5 Network

10 Original image

11 Current display area

12 New display area

21 CPU

22 Memory

23 Image synthesizing portion

24 Image selecting portion

25 Image data converting and processing portion

26, 44 Input/output interface

27 Hard disk

41 Image acquiring portion

42 Image adjusting portion

43 Display portion

45 Display information inputting portion

1. an image selecting portion configured to select an image to be displayed having a resolution determined based on a change speed of a display area.

2. An information processing apparatus according to claim 1, wherein the resolution is determined based on whether the change speed is greater than or less than a predetermined threshold.

3. An information processing apparatus according to claim 2, wherein if the change speed is less than the predetermined threshold, a high resolution image having a high resolution equal to or greater than a display magnification resolution corresponding to a display magnification of the display area is selected.

4. An information processing apparatus according to claim 2, wherein if the change speed is greater than the predetermined threshold, a low resolution image having a low resolution lower than a display magnification resolution corresponding to a display magnification of the display area is selected.

5. An information processing apparatus according to claim 1, wherein the image to be displayed includes a plurality of tile images that are adapted to be selected.

6. An information processing apparatus according to claim 5, further comprising:
an image data converging and processing portion configured to convert a data format of the tile images.

7. An information processing apparatus according to claim 1, further comprising:
an image data converting and processing portion configured to adjust a size of the image to be equal to a size of the display area if the resolution is not equal to a resolution corresponding to a display magnification.

8. An information processing apparatus according to claim 1, wherein the display area is configured to be changed by a user input.

9. An information processing apparatus according to claim 1, wherein the change speed is associated with at least one of a movement, an enlargement, a reduction, and a rotation of the display area.

10. An information processing apparatus according to claim 1, further comprising:
an image acquiring portion configured to acquire the image to be displayed.

11. An information processing apparatus according to claim 1, wherein the change speed is associated with a change of a focus position of the display area.

12. An information processing method comprising:
selecting an image to be displayed having a resolution determined based on a change speed of a display area.

13. A non-transitory computer readable storage medium storing a computer program for causing an information processing apparatus to:
select an image to be displayed having a resolution determined based on a change speed of a display area.

14. An image display device comprising:
a display portion; and
an image acquiring portion configured to acquire an image to be displayed having a resolution determined based on a change speed of a display area.

15. An image display device according to claim 14, further comprising:
a communication unit configured to transmit display area specifying information associated with the change speed.

16. An image display system comprising:
an information processing apparatus including an image selecting portion configured to select an image to be displayed having a resolution determined based on a change speed of a display area.

17. An image display system according to claim 16, further comprising:
a server including an image storing portion configured to store a plurality of images having a plurality of resolutions, wherein the image selecting portion selects the image from the plurality of images.

18. An image display system according to claim 16, further comprising:
an image display apparatus including:
an image acquiring portion configured to acquire the image to be displayed having the resolution determined based on the change speed;
and a display portion configured to display the image to be displayed.

19. An image display system according to claim 17, further comprising:
a microscope configured to provide a plurality of original images to the server, wherein the plurality of images having the plurality of resolutions correspond to the original images.
